(19) United States
(12) Patent Application Publication
(10) Pub. No.: US 2014/0145975 A1
(43) Pub. Date: May 29, 2014

(54) TOUCHSCREEN DEVICE AND SCREEN ZOOM METHOD THEREOF

(71) Applicant: SAMSUNG ELECTRO-MECHANICS CO., LTD., Suwon (KR)

(72) Inventors: Sang Hyun SIM, Suwon (KR); Yoon Seok Oh, Suwon (KR); Ji Hoon Kim, Suwon (KR); Sam Ki Jung, Suwon (KR)

(73) Assignee: SAMSUNG ELECTRO-MECHANICS CO., LTD., Suwon (KR)

(21) Appl. No.: 13/772,609

(22) Filed: Feb. 21, 2013

(30) Foreign Application Priority Data
Nov. 26, 2012 (KR) 10-2012-0134745

(51) Int. Cl. G06F 3/0488

(52) U.S. Cl. CPC G06F 3/0488
USPC 345/173

(57) ABSTRACT

There are provided a touchscreen device and a screen zoom method thereof, the touchscreen device including a panel unit to which a touch is input, a control unit generating a zoom signal according to a line touch input to the panel unit and having a predetermined length, and a display unit enlarging or shrinking a screen according to the zoom signal and outputting the screen.

### CROSS-REFERENCE TO RELATED APPLICATIONS

This application claims the priority of Korean Patent Application No. 10-2012-0134745 filed on Nov. 26, 2012, in the Korean Intellectual Property Office, the disclosure of which is incorporated herein by reference.

### BACKGROUND OF THE INVENTION

1. Field of the Invention

The present invention relates to a touchscreen device and a screen zoom method thereof.

2. Description of the Related Art

In general, a touchscreen device refers to a screen devised to directly receive input data such that when a user's fingertip or another object touches a character displayed thereon or in a particular position thereof, without using a keyboard, a corresponding position is recognized and a particular operation is performed by stored software.

A touchscreen is configured by adding a touch panel to a general display to perform a particular function, and there are various types of touchscreen, such as an infrared ray touchscreen, a resistive touchscreen, a capacitive touchscreen, and the like, according to types of touch panel.

Thus, when a user touches various types of information displayed on a screen equipped with a touch panel with his finger, an item selected by the user is recognized and a corresponding command is processed by a computer to allow the user to easily obtain desired information. Due to such characteristics, touchscreens have been variously utilized in facilities frequently used by the public or in various commercial settings, or for the purposes of business.

Meanwhile, the development of a central processing unit (CPU) or a memory installed in a portable multimedia device such as a portable terminal, or the like, allows for the execution of various applications such as playing games or video, as well as large capacity image files. Also, as various applications are available to be executed, the sizes of portable multimedia device displays have tended to be increased to allow applications to be smoothly used. Thus, in the case of a portable multimedia device including both a keypad as an input unit and a display as a display unit within a limited size, the size of the display is relatively reduced due to the presence of the keypad, so a technique of increasing the size of the display by incorporating the display and the input unit into a single device has generally been used.

However, even portable multimedia devices using a touchscreen are limited to displaying various types of information on a single screen due to a limited size in terms of portable device characteristics. In particular, when an e-map is viewed by using a portable multimedia device, when a large image file is viewed by using a portable multimedia device, or when an Internet Web page is searched, and the like, a screen is required to be frequently enlarged or shrunk due to the limited display size.

Patent Document 1 below relates to a digital image processing device and a method for enlarging and shrinking a screen based on touch, in which a screen is enlarged or shrunk based on a single circular trace. However, this technique has a difficulty in determining whether a touch gesture is intended to scroll or zoom a screen in its implementation, and when a size of a touchscreen device is large, it is not easy for a user to draw a trace with only a thumb while holding the device in one hand.

### RELATED ART DOCUMENT

(Patent Document 1) Korean Patent Laid-Open Publication No 10-2012-0019350

### SUMMARY OF THE INVENTION

An aspect of the present invention provides a touchscreen device allowing a user to easily enlarge or shrink a screen through an intuitive movement of the thumb while grasping the touchscreen device in one hand, and a screen zoom method of the touchscreen device.

According to an aspect of the present invention, there is provided a touchscreen device including: a panel unit to which a touch is input; a control unit generating a zoom signal according to a line touch input to the panel unit and having a predetermined length; and a display unit enlarging or shrinking a screen according to the zoom signal and outputting the screen.

When an angle between the line touch and a preset parallel line is within a predetermined range, the control unit may enter a zoom mode.

When the line touch is positioned within a predetermined distance from a left or right edge of the panel unit, the control unit may enter a zoom mode.

The control unit may determine a zoom rate for enlarging or shrinking the screen in proportion to an angle variation according to a rotation of the line touch.

When the angle variation has a positive value, the control unit may generate the zoom signal for enlarging the screen, while when the angle variation has a negative value, the control unit may generate the zoom signal for shrinking the screen.

The control unit may determine a zoom rate for enlarging or shrinking the screen in proportion to a difference in angles between the line touch and a preset parallel line according to a rotation of the line touch.

When the difference in angles has a positive value, the control unit may generate the zoom signal for enlarging the screen, while when the difference in angles has a negative value, the control unit may generate the zoom signal for shrinking the screen.

The zoom mode may include a left hand zoom mode and a right hand zoom mode, the control unit calculates a first distance from the line touch to the left edge and a second distance from the line touch to the right edge, and when the first distance is smaller than the second distance, the control unit enters the left hand zoom mode, while when the second distance is smaller than the first distance, the control unit enters the right hand zoom mode.

When the control unit enters the left hand zoom mode, if a rotation of the line touch is a counterclockwise direction, the control unit may generate the zoom signal for enlarging the screen, while if the rotation of the line touch is a clockwise direction, the control unit may generate the zoom signal for shrinking the screen, and when the control unit enters the right hand zoom mode, if the rotation of the line touch is the clockwise direction, the control unit may generate the zoom signal for enlarging the screen, while if the rotation of the line touch is the counterclockwise direction, the control unit may generate the zoom signal for shrinking the screen.

The control unit may determine a zoom rate for enlarging or shrinking the screen in proportion to an angle variation according to the rotation of the line touch.

The control unit may determine a zoom rate for enlarging or shrinking the screen in proportion to a difference in angles between the line touch and a preset parallel line according to the rotation of the line touch.

According to another aspect of the present invention, there is provided screen zoom method of a touchscreen device, including: detecting a line touch from touch data; entering a zoom mode according to a position to which the line touch is input; determining a zoom rate for enlarging or shrinking a screen in proportion to an angle variation according to a rotation of the line touch; and determining whether to enlarge or shrink the screen according to a sign of the angle variation.

In the entering of the zoom mode, when an angle between the line touch and a preset parallel line is within a predetermined range, the zoom mode may be entered.

In the entering of the zoom mode, when the line touch is positioned within a predetermined distance from a left or right edge of a panel unit, the zoom mode may be entered.

In the determining whether to enlarge or shrink the screen, when the angle variation has a positive value, the screen may be determined to be enlarged, while when the angle variation has a negative value, the screen may be determined to be shrunk.

The zoom mode may include a left hand zoom mode and a right hand zoom mode, and in the entering of the zoom mode, a first distance from the line touch to the left edge and a second distance from the line touch to the right edge may be calculated, and when the first distance is smaller than the second distance, the left hand zoom mode may be entered, while when the second distance is smaller than the first distance, the right hand zoom mode may be entered.

In the determining whether to enlarge or shrink the screen, when the left hand zoom mode is entered, if the rotation of the line touch is a counterclockwise direction, the screen may be determined to be enlarged, while if the rotation of the line touch is a clockwise direction, the screen may be determined to be shrunk, and when the right hand zoom mode is entered, if the rotation of the line touch is the clockwise direction, the screen may be determined to be enlarged, while if the rotation of the line touch is the counterclockwise direction, the screen may be determined to be shrunk.

According to another aspect of the present invention, there is provided a screen zoom method of a touchscreen device, including: detecting a line touch from touch data; entering a zoom mode according to a position to which the line touch is input; determining a zoom rate for enlarging or shrinking a screen in proportion to a difference in angles between the line touch and a preset parallel line according to a rotation of the line touch; and determining whether to enlarge or shrink the screen according to a sign of the difference in angles.

In the entering of the zoom mode, when an angle between the line touch and the parallel line is within a predetermined range, the zoom mode may be entered.

In the entering of the zoom mode, when the line touch is positioned within a predetermined distance from a left or right edge of a panel unit, the zoom mode may be entered.

In the determining whether to enlarge or shrink the screen, when the difference in angles has a positive value, the screen may be determined to be enlarged, while when the angle difference value has a negative value, the screen may be determined to be shrunk.

The zoom mode may include a left hand zoom mode and a right hand zoom mode, and in the entering of the zoom mode, a first distance from the line touch to the left edge and a second distance from the line touch to the right edge may be calculated, and when the first distance is smaller than the second distance, the left hand zoom mode may be entered, and when the second distance is smaller than the first distance, the right hand zoom mode may be entered.

In the determining whether to enlarge or shrink the screen, when the left hand zoom mode is entered, if the rotation of the line touch is a counterclockwise direction, the screen may be determined to be enlarged, while if the rotation of the line touch is a clockwise direction, the screen may be determined to be shrunk, and when the right hand zoom mode is entered, if the rotation of the line touch is the clockwise direction, the screen may be determined to be enlarged, while if the rotation of the line touch is the counterclockwise direction, the screen may be determined to be shrunk.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating an electronic device to which a touchscreen device according to an embodiment of the present invention is applicable;

FIG. 2 is a plan view illustrating a panel unit as an element of the touchscreen device according to the embodiment of the present invention;

FIG. 3 is a cross-sectional view of the panel unit illustrated in FIG. 2;

FIG. 4 is a block diagram of a touchscreen device according to an embodiment of the present invention;

FIG. 5 is a block diagram of a touchscreen device according to another embodiment of the present invention;

FIG. 6 is a view illustrating a line touch according to an embodiment of the present invention;

FIGS. 7 and 8 are flow charts illustrating a screen zoom method of a touchscreen device according to an embodiment of the present invention;

FIG. 9 is a view illustrating a parallel line according to an embodiment of the present invention; and

FIGS. 10 and 11 are views illustrating a method for determining a zoom rate according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

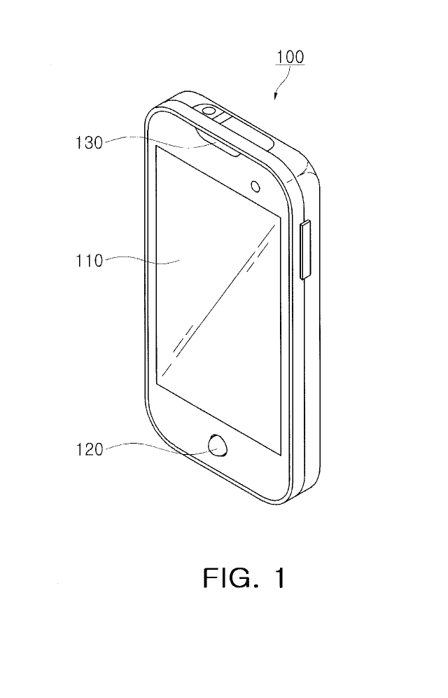

FIG. 1 is a view illustrating an electronic device to which a touchscreen device according to an embodiment of the present invention is applicable. Referring to FIG. 1, an electronic device 100 according to the present embodiment may include a display unit 110 for outputting a screen therethrough, an input unit 120, an audio unit 130 for outputting a sound, and a panel unit may be integrated with the display unit 110.

As illustrated in FIG. 1, in the case of the mobile device, in general, a panel unit is integrated with the display unit, and the panel unit is required to have as high a level of light transmittance as possible so as to allow an image displayed on the display unit to be transmitted therethrough. Thus, the panel unit may be implemented by forming a sensing electrode on a base substrate formed of a transparent film material such as polyethylene terephthalate (PET), polycarbonate (PC), polyethersulfone (PES), polyimide (PI) or the like and the sensing electrode is formed of an electrically conductive material such as indium-tin oxide (ITO), indium zinc oxide (IZO), zinc oxide (ZnO), carbon nanotubes (CNT), a conductive polymer, or graphene. A wiring pattern connected to the sensing electrode made of a transparent conductive material is disposed in a bezel region of the display unit, and since the wiring pattern is visually shielded by the bezel region, the wiring pattern may also be made of a metal such as silver (Ag), copper (Cu), or the like.

In the case that the panel unit according to an embodiment of the present invention is not required to be integrated with a display device such as a touch pad, or the like, of a notebook computer, a sensing electrode may be simply patterned using a metal on a circuit board so as to be fabricated. However, hereinafter, the touchscreen device in which a panel unit is integrated with the display unit 110 according to an embodiment of the present invention will be described for the purposes of description.

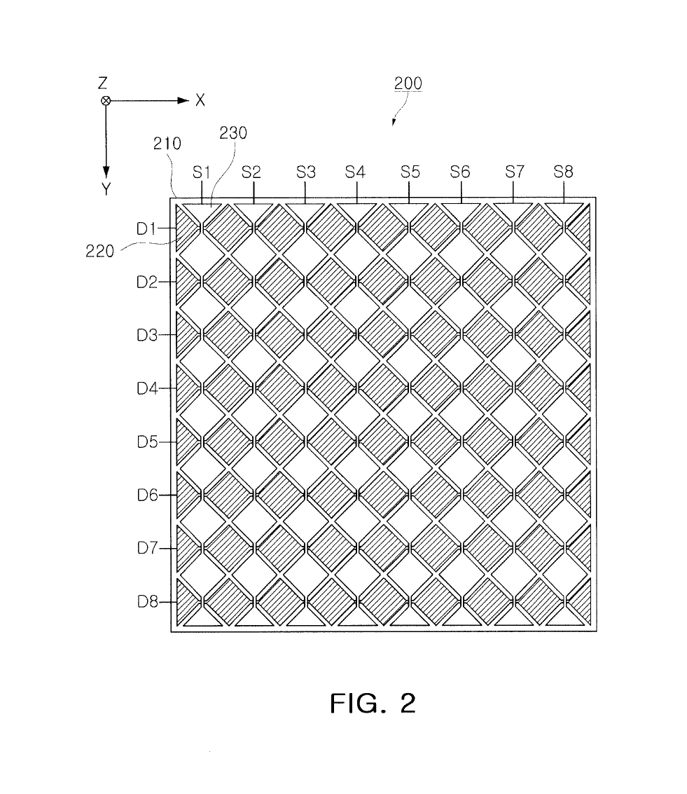

FIG. 2 is a plan view illustrating the panel unit as an element of the touchscreen device according to an embodiment of the present invention;

Referring to FIG. 2, a panel unit 200 according to the present embodiment includes a substrate 210 and a plurality of sensing electrodes 220 and 230 provided on the substrate 210. Although not shown, the plurality of sensing electrodes 220 and 230 may be respectively electrically connected with wiring patterns of a circuit board, which is bonded to one end of the substrate, through wirings and bonding pads. A controller integrated circuit is mounted on the circuit board to detect a sensing signal generated from the plurality of sensing electrodes 220 and 230 and determine a touch input from the sensing signal.

In the case of the touchscreen device, the substrate 210 may be a transparent substrate on which the sensing electrodes 220 and 230 are formed, and may be formed of a plastic material such as polyimide (PI), polymethylmethacrylate (PMMA), polyethyleneterephthalate (PET), or polycarbonate (PC), or tempered glass. Further, with respect to a region in which the wirings connected to the sensing electrodes 220 and 230 are formed, except for a region in which the sensing electrodes 220 and 230 are formed, a predetermined printing region may be formed on the substrate 210 in order to visually shield the wirings which are generally formed of an opaque metal material.

The plurality of sensing electrodes 220 and 230 may be provided on one surface or both surfaces of the substrate 210. The touchscreen device may be formed of indium tin-oxide (ITO), indium zinc-oxide (IZO), zinc oxide (ZnO), carbon nano tube (CNT), a graphene based material, or the like, having transparency and conductivity. In FIG. 2, the sensing electrodes 220 and 230 having a diamond-like pattern are illustrated, but the present invention is not limited thereto and the sensing electrodes 220 and 230 may have various polygonal patterns such as a rectangular pattern, a triangular pattern, or the like.

The plurality of sensing electrodes 220 and 230 include first electrodes 220 extending in an X-axis direction and second electrodes 230 extending in a Y-axis direction. The first electrodes 220 and the second electrodes 230 may intersect each other on both surfaces of the substrate 210, or on different substrates 210. In the case in which the first electrodes 220 and the second electrodes 230 are all formed on one surface of the substrate 210, predetermined insulating layers may be partially formed in intersections between the first electrodes 220 and the second electrodes 230.

The touchscreen device may detect changes in capacitance generated in the plurality of sensing electrodes 220 and 230 according to a touch input applied thereto and sense the touch input based on the detected changes in capacitance. The first electrodes 220 may be connected to channels D1 to D8 to receive a predetermined driving signal from the controller integrated circuit, and the second electrode 230 may be connected to channels S1 to S8 to allow the touchscreen device to detect a sensing signal. Here, the controller integrated circuit may detect, as a sensing signal, changes in mutual-capacitance generated between the first electrodes 220 and the second electrodes 230, and may be operated in such a manner that driving signals are sequentially applied to the respective first electrodes 220 and the changes in capacitance are simultaneously detected by the second electrodes 23.

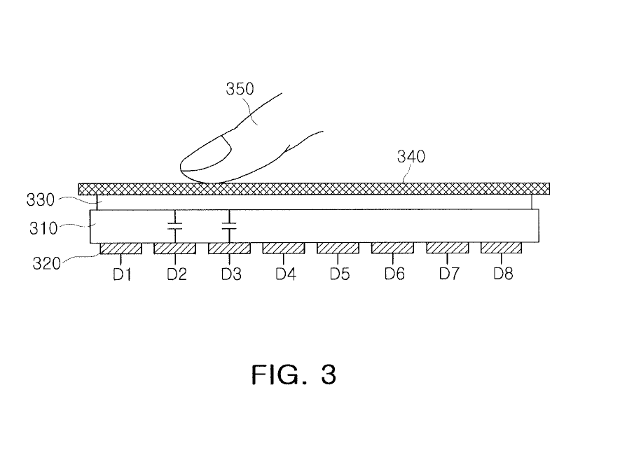

FIG. 3 is a cross-sectional view of the panel unit illustrated in FIG. 2.

FIG. 3 is a cross-sectional view of the panel unit 200 illustrated in FIG. 2, taken along Y-Z plane, and the panel unit 200 may include a substrate 310 and a plurality of sensing electrodes 320 and 330 as described above with reference to FIG. 2 and further include a cover lens 340 receiving contact. The cover lens 340 may be disposed on the second electrode 330 used for detecting a sensing signal and receive a touch input from a contact object 350 such as a finger, or the like.

When driving signals are sequentially applied to the first electrodes 320 through channel D1 to D8, mutual capacitance may be generated between the first electrodes 320 to which the driving signals are applied and the second electrode 330. When the driving signals are sequentially applied to the first electrodes 320, changes in mutual capacitance generated between the first electrodes 320 and the second electrode 330 adjacent to a region with which the contact object 350 is brought into contact may be caused. The changes in capacitance may be proportional to the area of an overlapping region between the contact object 350 and the first electrodes 320 to which the driving signals are applied and the second electrode 330. In FIG. 3, mutual capacitance generated between the first electrodes 320 and the second electrode 330 connected to the channels D2 and D3 is affected by the contact object 350.

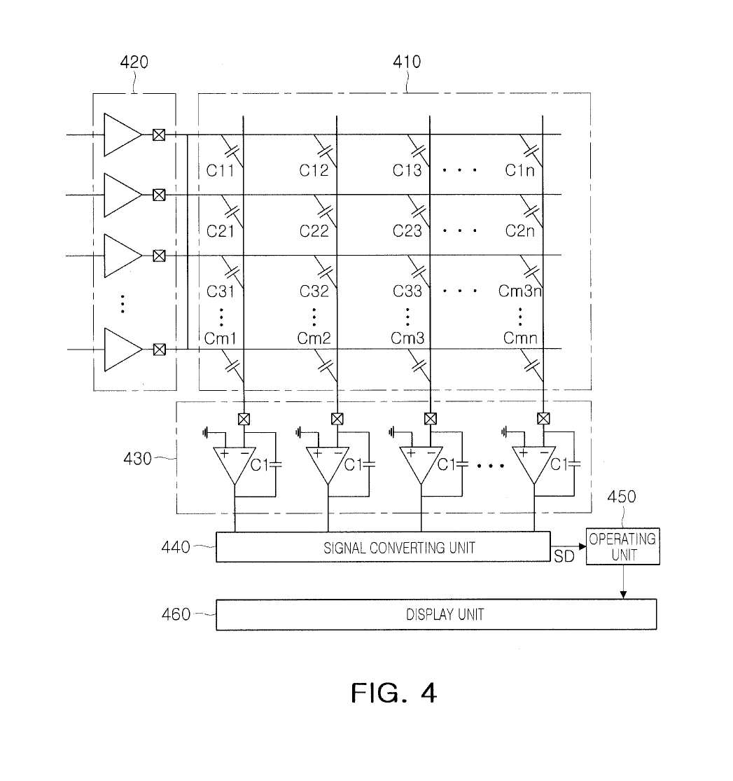

FIG. 4 is a block diagram of the touchscreen device according to an embodiment of the present invention.

Referring to FIG. 4, a touchscreen device according to the present embodiment includes a panel unit 410, a driving circuit unit 420, a sensing circuit unit 430, a signal converting unit 440, an operating unit 450, and a display unit 460. The panel unit 410 includes a plurality of first electrodes extending in a first axis direction (or a horizontal direction in FIG. 4) and a plurality of second electrodes extending in a second axis direction (or a vertical direction in FIG. 4). Changes in capacitance C11 to Cmn are generated in a plurality of nodes in which the first electrodes and the second electrodes intersect with each other. The changes in capacitance C11 to Cmn generated in the plurality of nodes may be the changes in mutual-capacitance generated by the driving signals applied to the first electrodes from the driving circuit unit 420. Meanwhile, the driving circuit unit 420, the sensing circuit unit 430, the signal converting unit 440, and the operating unit 450 may be implemented as a single integrated circuit (IC).

The driving circuit unit 420 may apply predetermined driving signals to the first electrodes of the panel unit 410. The driving signals may include a square wave signal, a sine wave signal, a triangle wave signal, and the like, which have a predetermined period and amplitude, and may be sequentially applied to the plurality of first electrodes. FIG. 4 illustrates that circuits for applying driving signals are individually connected to the plurality of the first electrodes. However, alternatively, a single driving signal generating circuit may be provided and driving signals may be applied to the respective first electrodes by using a switching circuit.

The sensing circuit unit 430 may include an integration circuit for sensing the changes in capacitance C11 to Cmn generated in the plurality of nodes. The integration circuit may be connected to the plurality of second electrodes. The integration circuit may include at least one operational amplifier and a capacitor C1 having a predetermined capacitance. An inverting input terminal of the at least one operational amplifier is connected to the second electrodes, and thus, the changes in capacitance C11 to Cmn are converted into an analog signal such as a voltage signal or the like to be output. When driving signals are sequentially applied to the plurality of respective first electrodes, since changes in capacitance C11 to Cmn may be simultaneously detected from the second electrodes, the integration circuit may be provided in an amount equal to m number of second electrodes.

The signal converting unit 440 generates a digital signal S_{D} from the analog signal generated by the integration circuit. For example, the signal converting unit 440 may include a time-to-digital converter (TDC) circuit for measuring a period of time for which an analog signal output in the form of voltage from the sensing circuit unit 430 reaches a predetermined reference voltage level and converting the period of time into the digital signal S_{D} or an analog-to-digital converter (ADC) circuit for measuring an amount by which a level of the analog signal output from the sensing circuit unit 430 is changed for a predetermined period of time and converting the amount into the digital signal S_{D}. The operating unit 450 determines a touch input applied to the panel unit 410 by using the digital signal S_{D}. For example, the operating unit 450 may determine the number of touch inputs applied to the panel unit 410, coordinates of the touch input, a gesture based on the touch input, or the like.

Meanwhile, in an embodiment of the present invention, the operating unit 450 may determine information regarding a direction of the touch input in addition to the coordinates of the touch input applied to the panel unit 410, the number of touch inputs, and gestures. The operating unit 450 may control the display unit 460 to change an output image according to a touch input applied to the panel unit 410 by a user.

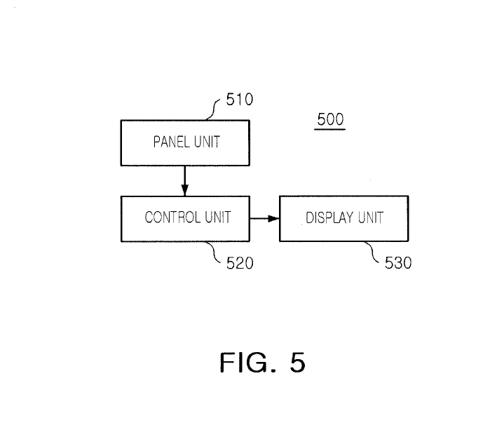

FIG. 5 is a block diagram of a touch screen device according to another embodiment of the present invention. Referring to FIG. 5, the touchscreen device according to another embodiment of the present invention may include a panel unit 510, a control unit 520, and a display unit 530. The control unit 520 of FIG. 5 is an element corresponding to the driving circuit unit 420, the sensing circuit unit 430, the signal converting unit 440, and the operating unit 450, so a repeated description thereof will be omitted.

When a line touch having a predetermined length is applied to the panel unit 510, the control unit 520 may sense the line touch and generate a zoom signal. The zoom signal is a control signal provided to the display unit 530 in order to enlarge or shrink a screen output from the display unit 530. Upon receiving the zoom signal, the display unit 530 may shrink or enlarge the screen to output the screen.

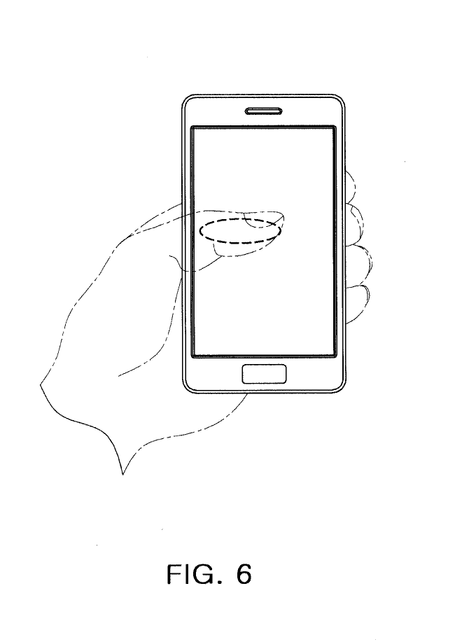

FIG. 6 is a view illustrating a line touch according to an embodiment of the present invention. Referring to FIG. 6, it can be seen that a line touch is input to a touch panel integrated with a display unit, the line touch extending in a direction from a contacting object such as user's finger, or the like.

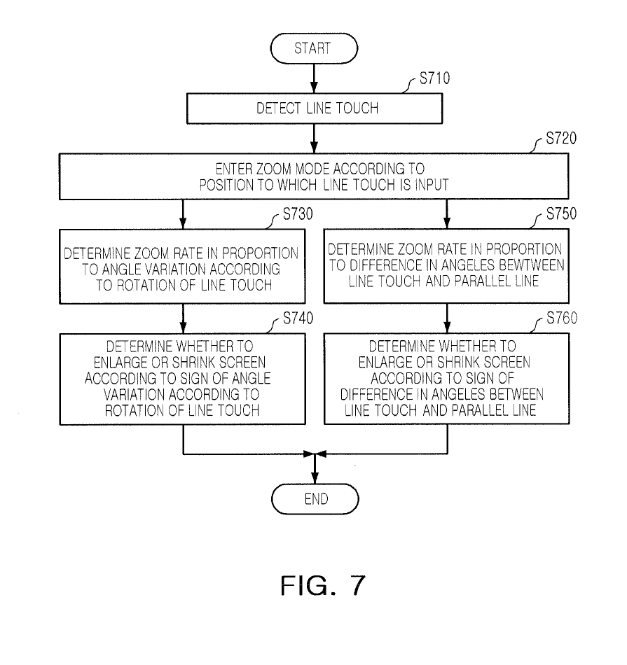

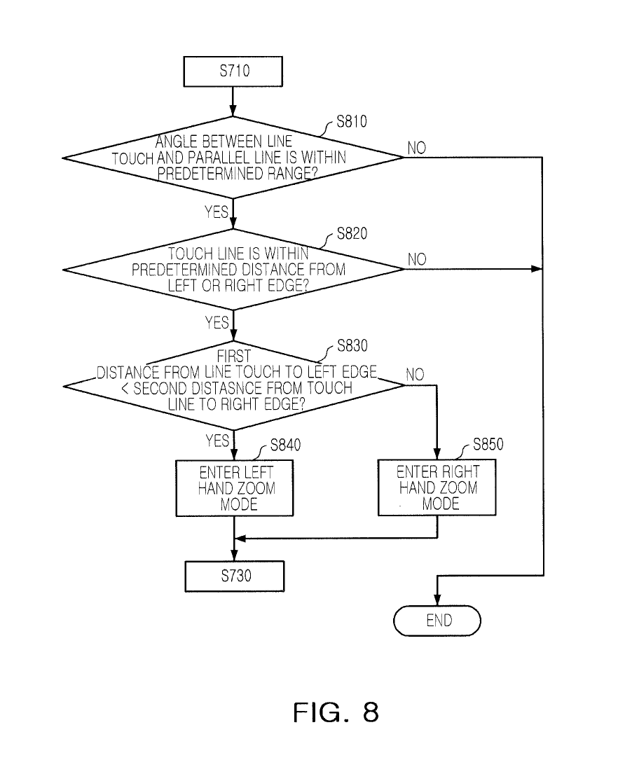

FIGS. 7 and 8 are flow charts illustrating a screen zoom method of a touchscreen device according to an embodiment of the present invention. The screen zoom method of a touchscreen device according to an embodiment of the present invention will be described in detail with reference to FIGS. 5, 7, and 8.

Referring to FIGS. 5 and 7, the control unit senses a line touch having a predetermined length and input to the panel unit (S710). Here, the predetermined length may refer to a preset length and the control unit may recognize a line touch having a predetermined length as a touch input for enlarging or zooming a screen.

The control unit may enter a zoom mode for generating the zoom signal for enlarging or shrinking a screen according to a position to which a line touch is input (S720). A process of entering the zoom mode will be described with reference to FIG. 8.

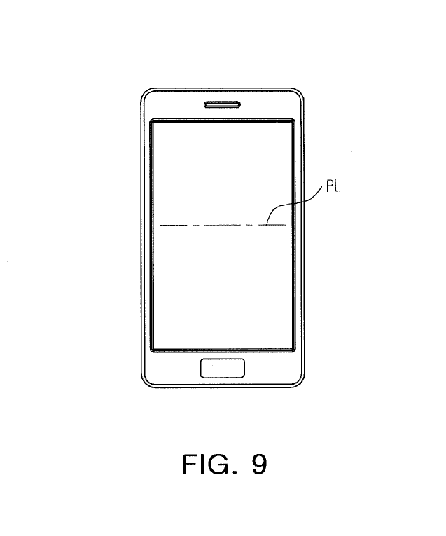

Referring to FIG. 8, in order to determine whether to enter the zoom mode, the control unit determines whether an angle between the line touch and a preset parallel line is within a predetermined range (S810). FIG. 9 is a view illustrating a parallel line according to an embodiment of the present invention. Referring to FIG. 9, it can be seen that a parallel line (PL) may be a line parallel to a width of the display unit.

When the angle between the line touch and the parallel line is outside of the predetermined range, the control unit may not enter the zoom mode, but when the angle between the line touch and the parallel line is within the predetermined range, the control unit may determine whether the line touch is positioned within a predetermined distance from a left or right edge of the panel unit (S820)

Thereafter, when the line touch is not positioned within the predetermined distance from the left or right edge of the panel unit, the control unit may not enter the zoom mode, but when the line touch is positioned within the predetermined distance from the left or right edge of the panel unit, the control unit may calculate a first distance from the line touch to the left edge and a second distance from the line touch to the right edge and compare the first distance and the second distance (S830). Here, when the first distance is smaller than the second distance, the control unit may determine that the user applies a touch to the panel unit with his left hand, and enter a left hand zoom mode (S840), and when the second distance is smaller than the first distance, the control unit may determine that the user applies a touch to the panel unit with his right hand, and enter a right hand zoom mode (S850).

In FIG. 8, operations S810 to S850 are illustrated as sequential operations for entering the left or right hand zoom mode, but according to an embodiment of the present invention, at least one of operations S810 and S820, as an operation for entering a zoom mode without entering the right hand zoom mode and the left hand zoom mode, may be performed as an independent method.

Referring to FIG. 7, after operation S720, any one of operations S730 and S750 may be performed according to a setting.

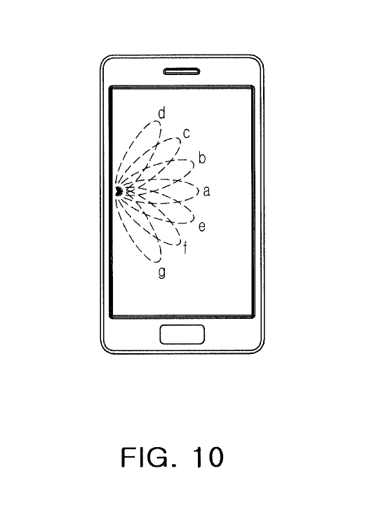

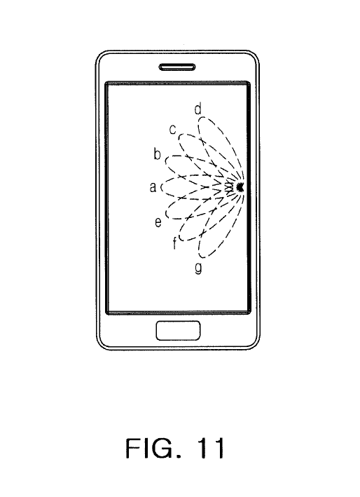

After entering the zoom mode, the control unit may sense a rotation of the line touch and determine a zoom rate in proportion to an angle variation according to the rotation (S730). FIGS. 10 and 11 are views illustrating a method for determining a zoom rate according to an embodiment of the present invention. A process of determining a zoom rate will be described with reference to FIGS. 10 and 11.

For example, when an angle variation according to a rotation from a to b, an angle variation according to a rotation from b to c, and an angle variation according to a rotation from c to d are all equal, the control unit may set the same zoom rate of the screen for the rotations from a to b, from b to c, and from c to d, thereby determining the zoom rate in proportion to the angle variation.

Thereafter, the control unit may determine whether to enlarge or shrink the screen according to a sign of an angle variation of a line touch (S740). For example, in case of rotation from g to d, the control unit may enlarge the screen such that the angle is changed in a positive direction, and in the case of rotation from d to g, the control unit may shrink the screen such that the angle is changed in a negative direction.

Also, unlike the above case, the zoom rate may be determined in proportion to a difference in angles between the line touch and the parallel line (S750). For example, in the case that angles between a, b, c, and d and the parallel line are 0, 22.5, 45, and 67.5, respectively, the control unit may set the zoom ratio such that the zoom rate is two-fold per preset unit time when the line touch is positioned in b, the zoom rate is four-fold when the line touch is positioned in c, and the zoom rate is eight-fold when the line touch is positioned in d, thereby determining the zoom rate in proportion to the difference in angles between the line touch and the parallel line.

Thereafter, the control unit may determine whether to enlarge or shrink the screen according to a sign of the difference in angles between the line touch and the parallel line (S760). For example, when the line touch is positioned between b and d in FIG. 10, the difference in angles has a positive value, such that the screen is enlarged, while when the line touch is positioned between e and g, the difference in angles has a negative value, such that the screen may be shrunk.

Also, when the control unit enters the left hand zoom mode or the right hand zoom mode, the control unit may determine whether to enlarge or shrink the screen according to a direction of the rotation. Here, the zoom rate of the screen may be determined according to the foregoing method. Referring to FIG. 10, the line touch of FIG. 10 is closer to the left edge of the panel unit than to the right edge of the panel unit. Thus, in this case, the control unit may determine that the left hand zoom mode has been entered, and when the line touch rotates in a direction from g to d, i.e., in a counterclockwise direction, the control unit may generate a zoom signal for enlarging the screen, while when the line touch rotates in a direction from d to g, i.e., in a clockwise direction, the control unit may generate a zoom signal for shrinking the screen.

Also, referring to FIG. 11, the line touch of FIG. 11 is closer to the right edge of the panel unit than to the left edge of the panel unit. Thus, in this case, the control unit may determine that the right hand zoom mode has been entered, while when the line touch rotates in the direction from g to d, i.e., in the clockwise direction, the control unit may generate the zoom signal for enlarging the screen, while when the line touch rotates in the direction from d to g, i.e., in the counterclockwise direction, the control unit may generate the zoom signal for shrinking the screen.

As set forth above, according to the embodiments of the invention, a touchscreen device allowing a user to easily enlarge or shrink a screen through an intuitive movement of the thumb while grasping the touchscreen device in one hand, and a screen zoom method of the touchscreen device can be provided.

While the present invention has been shown and described in connection with the embodiments, it will be apparent to those skilled in the art that modifications and variations can be made without departing from the spirit and scope of the invention as defined by the appended claims.

What is claimed is:

1. A touchscreen device comprising:
a panel unit to which a touch is input;
a control unit generating a zoom signal according to a line touch input to the panel unit and having a predetermined length; and
a display unit enlarging or shrinking a screen according to the zoom signal and outputting the screen.

2. The touchscreen device of claim 1, wherein when an angle between the line touch and a preset parallel line is within a predetermined range, the control unit enters a zoom mode.

3. The touchscreen device of claim 1, wherein when the line touch is positioned within a predetermined distance from a left or right edge of the panel unit, the control unit enters a zoom mode.

4. The touchscreen device of claim 1, wherein the control unit determines a zoom rate for enlarging or shrinking the screen in proportion to an angle variation according to a rotation of the line touch.

5. The touchscreen device of claim 4, wherein when the angle variation has a positive value, the control unit generates the zoom signal for enlarging the screen, while when the angle variation has a negative value, the control unit generates the zoom signal for shrinking the screen.

6. The touchscreen device of claim 1, wherein the control unit determines a zoom rate for enlarging or shrinking the screen in proportion to a difference in angles between the line touch and a preset parallel line according to a rotation of the line touch.

7. The touchscreen device of claim 6, wherein when the difference in angles has a positive value, the control unit generates the zoom signal for enlarging the screen, while when the difference in angles has a negative value, the control unit generates the zoom signal for shrinking the screen.

8. The touchscreen device of claim 3, wherein the zoom mode includes a left hand zoom mode and a right hand zoom mode,
the control unit calculates a first distance from the line touch to the left edge and a second distance from the line touch to the right edge, and
when the first distance is smaller than the second distance, the control unit enters the left hand zoom mode, while when the second distance is smaller than the first distance, the control unit enters the right hand zoom mode.

9. The touchscreen device of claim 8, wherein when the control unit enters the left hand zoom mode, if a rotation of the line touch is a counterclockwise direction, the control unit generates the zoom signal for enlarging the screen, while if the rotation of the line touch is a clockwise direction, the control unit generates the zoom signal for shrinking the screen, and
when the control unit enters the right hand zoom mode, if the rotation of the line touch is the clockwise direction, the control unit generates the zoom signal for enlarging the screen, while if the rotation of the line touch is the counterclockwise direction, the control unit generates the zoom signal for shrinking the screen.

10. The touchscreen device of claim 9, wherein the control unit determines a zoom rate for enlarging or shrinking the screen in proportion to an angle variation according to the rotation of the line touch.

11. The touchscreen device of claim 9, wherein the control unit determines a zoom rate for enlarging or shrinking the screen in proportion to a difference in angles between the line touch and a preset parallel line according to the rotation of the line touch.

12. A screen zoom method of a touchscreen device, the screen zoom method comprising:
detecting a line touch from touch data;
entering a zoom mode according to a position to which the line touch is input;
determining a zoom rate for enlarging or shrinking a screen in proportion to an angle variation according to a rotation of the line touch; and
determining whether to enlarge or shrink the screen according to a sign of the angle variation.

13. The method of claim 12, wherein in the entering of the zoom mode,
when an angle between the line touch and a preset parallel line is within a predetermined range, the zoom mode is entered.

14. The method of claim 12, wherein in the entering of the zoom mode,
when the line touch is positioned within a predetermined distance from a left or right edge of a panel unit, the zoom mode is entered.

15. The method of claim 12, wherein in the determining whether to enlarge or shrink the screen, when the angle variation has a positive value, the screen is determined to be enlarged, while when the angle variation has a negative value, the screen is determined to be shrunk.

16. The method of claim 14, wherein the zoom mode includes a left hand zoom mode and a right hand zoom mode, and
in the entering of the zoom mode, a first distance from the line touch to the left edge and a second distance from the line touch to the right edge are calculated, and when the first distance is smaller than the second distance, the left hand zoom mode is entered, while when the second distance is smaller than the first distance, the right hand zoom mode is entered.

17. The method of claim 16, wherein in the determining whether to enlarge or shrink the screen,
when the left hand zoom mode is entered, if the rotation of the line touch is a counterclockwise direction, the screen is determined to be enlarged, while if the rotation of the line touch is a clockwise direction, the screen is determined to be shrunk, and
when the right hand zoom mode is entered, if the rotation of the line touch is the clockwise direction, the screen is determined to be enlarged, while if the rotation of the line touch is the counterclockwise direction, the screen is determined to be shrunk.

18. A screen zoom method of a touchscreen device, the screen zoom method comprising:
detecting a line touch from touch data;
entering a zoom mode according to a position to which the line touch is input;
determining a zoom rate for enlarging or shrinking a screen in proportion to a difference in angles between the line touch and a preset parallel line according to a rotation of the line touch; and
determining whether to enlarge or shrink the screen according to a sign of the difference in angles.

19. The method of claim 18, wherein in the entering of the zoom mode,
when an angle between the line touch and the parallel line is within a predetermined range, the zoom mode is entered.

20. The method of claim 18, wherein in the entering of the zoom mode,
when the line touch is positioned within a predetermined distance from a left or right edge of a panel unit, the zoom mode is entered.

21. The method of claim 18, wherein in the determining whether to enlarge or shrink the screen,
when the difference in angles has a positive value, the screen is determined to be enlarged, while when the angle difference value has a negative value, the screen is determined to be shrunk.

22. The method of claim 20, wherein the zoom mode includes a left hand zoom mode and a right hand zoom mode, and
in the entering of the zoom mode, a first distance from the line touch to the left edge and a second distance from the line touch to the right edge are calculated, and when the first distance is smaller than the second distance, the left hand zoom mode is entered, while when the second distance is smaller than the first distance, the right hand zoom mode is entered.

23. The method of claim 22, wherein in the determining whether to enlarge or shrink the screen,
when the left hand zoom mode is entered, if the rotation of the line touch is a counterclockwise direction, the screen is determined to be enlarged, while if the rotation of the line touch is a clockwise direction, the screen is determined to be shrunk, and
when the right hand zoom mode is entered, if the rotation of the line touch is the clockwise direction, the screen is determined to be enlarged, while if the rotation of the line touch is the counterclockwise direction, the screen is determined to be shrunk.
